(19) United States
(12) Patent Application Publication
(10) Pub. No.: US 2008/0294789 A1
(43) Pub. Date: Nov. 27, 2008

(54) METHOD AND DEVICE FOR TRANSMITTING DATA

(75) Inventors: Eric Nassor, THORIGNE FOUILLARD (FR); Frederic Maze, LANGAN (FR)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/123,317

(22) Filed: May 19, 2008

(30) Foreign Application Priority Data
May 24, 2007 (FR) 0703685

(51) Int. Cl. G06F 15/16

(52) U.S. Cl. 709/231

(57) ABSTRACT

To transmit data between a server and at least one client in a communication network, this data having to comply with a first transmission latency, for a first processing to be carried out by a first client, and with a greater second latency, for a second processing to be carried out by a second client: the server determines, from the data, taking account of the variable available bandwidth, a first data stream having a rate compatible with the first latency; it transmits this first stream to the clients; it determines, from the data not included in the first stream, taking account of the variable available bandwidth, a second data stream having a rate compatible with the second latency; and it transmits this second stream to the second client. The calculation of the rate of the first stream takes account of the unsent quantity of data of the second stream.

The present invention relates to a method of transmitting data between a server and at least one client in a communication network, as well as a server implementing such a method.

It belongs to the field of the transmission of multimedia data, in particular audio and/or video, in a communication network such as an IP (Internet Protocol) network.

It applies in particular to the sequencing of the data packets in a stream of data transmitted from a sending device, such as a server, to a receiving device, such as a client.

A non-limiting example of application of the invention concerns the transmission of a video live from a camera to one or more clients which, simultaneously, display a video with a very small delay (hereinafter designated by the term “latency”) (typically a few tens of milliseconds) and record the video stream for its subsequent display.

Such a situation arises for example in the case of a small digital video surveillance or video conferencing camera connected to a communication network. The images are coded in a digital compression format and then stored locally in a buffer having a very limited capacity before being transmitted over a data communication network to one or more clients.

The video can be coded in accordance with one of the standards described in the H263 or H264 recommendations of the ITU-T, or MPEG4. These formats make it possible in fact to easily create data having two quality layers or levels, in the sense of temporal scalability or coding hierarchy. Some formats make it possible to have many quality levels, each level adding quality to the lower levels; this is the case with the H263+, MPEG4 part 2 FGS, or SVC (Scalable Video Coding) formats. In the in no way limiting case where the invention is applied to video data, it can be applied to any video format offering at least two quality levels.

Data communication networks may prove to be unreliable because of transmission errors, congestions or temporary stoppages of connections, which may give rise to lesser or greater losses of data packets.

Thus many data networks, such as the IP network or the asynchronous transfer mode (ATM), comprise interconnection nodes (routers, switches, etc.) in order to route the data packets coming from source devices to destination devices. In this type of network, congestion is the main source of loss when various data streams are caused to transit through the same link of insufficient capacity. Surplus packets generally end up by being rejected by the interconnection node situated at the entry to the link.

In addition, the congestion control mechanisms generally used in IP networks are of the TFRC (TCP Friendly Rate Control, IETF RFC3448) or AIMD (Additive Increase/Multiplicative Decrease, IETF RFC2581) type; however, these mechanisms produce, by their very nature, a plurality of congestions, even if they are of short duration.

In the case of congestion, the interconnection nodes reject a greater or lesser number of data packets in order to keep the filling level of the reception buffers below an acceptable threshold.

There is therefore at the same time a limited and variable communication rate and packet losses.

In the case mentioned above of a video surveillance camera, the user needs to see the filmed scene live. A data packet that arrives more than 100 ms after the shooting no longer has any interest since it is no longer usable by the user. Thus, if a packet is lost, the server has little chance of being able to resend it sufficiently rapidly.

In addition, the saving of the video by the client may be useful if an important event has occurred, to enable the client to review what has happened. In this second case, the latency does not need to be low: typically, the device that receives the video can store several seconds of data before saving them on a carrier. As long as they are not saved, the packets can be re-sequenced. However, such a system does not tolerate an excessively long latency: this is because this method requires random access memory, which remains of limited size. The late packets must therefore be received within a time limit that will be termed “long latency” (typically a few seconds). In this second case, the retransmission packets are very useful since they make it possible to correct the network losses in an optimal fashion.

Another problem relating to low latency is that, in order to adapt to variations in rate of the network, the coder on the camera will have to change the compression ratio of the images very rapidly. This is because, if it does not quickly reduce the quantity of data produced for each image when the network rate drops, the data will quickly become late and therefore some of the data risks arriving too late for the client wishing to display it.

However, rapid changes in the compression ratio will lead to a significant degradation in the visual quality experienced by a user. This is because the human psycho-visual system is particularly sensitive to changes in quality of the images.

In the case of a longer latency, the coder can adapt the compression ratio gently and continuously in order to avoid an abrupt change in quality. This gentle adaptation is advantageous both for a drop in quality and an increase in quality.

Thus the simple solution consisting of using the same data both for the video displayed live and for a recorded video does not make it possible best to use the latency characteristics of each client.

The other simple solution consisting of sending two different independent streams is not satisfactory either: the bandwidth of the network is limited and it is not therefore possible to transmit two streams simultaneously, since this would require compressing the video excessively. The server can also not routinely store the data not sent in order to transmit it later since there is both limited memory on the server and a limit to the delay acceptable to the client storing the data.

The article by R. Rejaie et al. entitled “Layered Quality Adaptation for Internet Video Streaming”, published in IEEE Journal on Selected Areas of Communications, winter 2000, describes a system for adapting the transmission rate of a video coded in the form of several levels. The number of levels is adapted to the mean of the rate calculated by a congestion control algorithm of the AIMD type, the calculated value of which oscillates.

The server calculates an instantaneous network bandwidth and a mean bandwidth over the length of the period of oscillation of the AIMD algorithm. The algorithm has, on the one hand, a filling phase, when the instantaneous rate is high. In this case, the most important data is sent in advance and stored on the client. The algorithm has on the other hand an emptying phase, where the client uses the stored data in order to supplement the data received.

This solution cannot be applied when coded data is used live (in which case it is not possible to send data in advance).

The object of the present invention is to remedy the aforementioned drawbacks, limits and gaps of the prior art.

For this purpose, the present invention provides a method of transmitting data between a server and at least one client in a communication network, this data having to comply with a first transmission latency, suiting a processing of a first type to be performed by a first client, and a second transmission latency greater than the first transmission latency and suiting a processing of a second type to be performed by a second client, the first and second clients being able to be distinct or not, this method comprising steps consisting, for the server, of:
determining, from the aforementioned data, taking account of the variable available bandwidth in the network, a first data stream having a rate making it possible to comply with the first latency;
transmitting the first data stream to the first and second clients;
determining, from the data not included in the first data stream, taking account of the variable available bandwidth in the network, a second data stream having a rate making it possible to comply with the second latency; and
transmitting the second data stream to the second client,
   wherein the calculation of the rate of the first stream takes account of the unsent quantity of data of the second stream.

Thus the invention makes it possible to create a partitioning of the data into two streams: the first stream enables the first client to obtain for example the greatest part of the data before a first deadline and the second stream, in addition to the first stream, enables the second client to obtain for example the complete data item (with for example a better quality) before the second deadline. The two deadlines are complied with and the quality for the second client can thus be improved.

The invention also makes it possible to determine the time of sending the data while complying with the rate or bandwidth of the network, in order to obtain for example a good compromise between the quality of the data stream decoded by the client with a low latency and the quality of the same data stream decoded with a longer time period.

This makes it possible to avoid abrupt variations in quality of the data stream recorded by the client. In the case where the data stream is a video, the visual quality of the recorded video is therefore improved compared with a conventional solution that would consist of recording the video live, knowing that the psycho-visual system is very sensitive to abrupt variations in quality. In addition, the quality of the video displayed live is kept good: it is also smoothed, which makes it possible to avoid certain abrupt variations.

In addition, the mechanism is adapted to an unreliable network comprising for example a retransmission system in the case of lost packets and an error correction system of the FEC (Forward Error Correction) type.

According to a particular feature, the step of determining the first stream comprises a step consisting of determining the instantaneous bandwidth available in the network. The rate of the first stream can in this case be less than or equal to the available instantaneous bandwidth determined.

This feature is particularly advantageous when the first latency or deadline is short compared with the uncertainty (or variability) of the measurement of the network rate. By way of example, this is the case with a first latency of 20 ms and a TFRC measurement on a network with a Round-Trip Time (RTT) of 5 ms.

As a variant, the step of determining the first stream can comprise a step consisting of determining the mean bandwidth available in the network over a period of time corresponding to the first latency. The rate of the first stream can in this case be less than or equal to the available mean bandwidth determined.

This variant is particularly advantageous when the first latency or deadline is long compared with the uncertainty (or variability) of the measurement of the network rate. By way of example, this is the case with a first latency of 100 ms and an AIMD measurement on a network with a round-trip time of 1 ms.

In a first particular embodiment where the data is coded according to a first quality level and a second quality level higher than the first level, the first stream can comprise at least some of the data having the first quality level and the second stream can comprise at least some of the data having the second quality level.

This embodiment is particularly advantageous especially in the case of real-time coding with two quality levels. The invention thus applies to many video formats.

In this embodiment, when the data is organized in packets, a creation date being associated with each packet, according to a particular feature, the method can comprise a step consisting, for the server, of comparing the date of creation of the non-transmitted packets having the first quality level with the current date and determining whether the difference between these two dates is less than the first latency minus the transmission time between the server and the first client.

This particular feature is advantageous for example in the case of a transmission using the RTP protocol (Real-time Transport Protocol) in an IP network.

In a second particular embodiment where the data is coded according to a first plurality of quality levels and a second plurality of quality levels higher than the levels of the first plurality of levels, the step of determining the first data stream can comprise steps consisting, for the server, of:
determining the instantaneous bandwidth of the network;
comparing this instantaneous bandwidth and the bandwidth of the maximum quality level of the first plurality of quality levels;
if the aforementioned instantaneous bandwidth is lower than the bandwidth of the maximum quality level, decreasing the maximum quality level of the first plurality of quality levels so that the bandwidth of the decreased maximum quality level is less than the aforementioned instantaneous bandwidth and the bandwidth of the quality level immediately higher than the decreased maximum quality level is higher than the aforementioned instantaneous bandwidth.

This second particular embodiment is advantageous in particular in the case of coding with a format making it possible to have several hierarchical or scalability levels. The coder is thus simplified since it does not need to adapt dynamically to the variations in the network.

The invention applies particularly well to a wireless communication network.

Likewise it applies particularly well to the case of a video data stream.

For the same purpose as indicated above, the present invention also proposes a server for the transmission of data between a server and at least one client in a communication network, this data having to comply with a first transmission latency, suited to a processing of a first type to be performed by a first client, and a second transmission latency, greater than the first transmission latency and suited to a processing of a second type to be performed by a second client, the first and second clients being able to be distinct or not, this server comprising:
means for determining, from the aforementioned data, taking account of the variable available bandwidth in the network, a first data stream having a rate making it possible to comply with the first latency;
means for transmitting the first data stream to the first and second clients;
means for determining, from the data not included in the first data stream, taking account of the variable available bandwidth in the network, a second data stream having a rate making it possible to comply with the second latency; and
means for transmitting the second data stream to the second client,
   wherein the calculation of the rate of the first stream takes account of the unsent quantity of data of the second stream.

Still for the same purpose, the present invention also relates to an information storage means readable by a computer or a microprocessor storing instructions of a computer program, allowing the implementation of a transmission method as succinctly described above.

In a particular embodiment, the storage means is partially or totally removable.

Still for the same purpose, the present invention also relates to a computer program product loadable into a programmable apparatus, remarkable in that it comprises sequences of instructions for implementing a transmission method as succinctly described above, when this program is loaded into and run by the programmable apparatus.

The particular features and advantages of the transmission server, of the information storage means and of the computer program product being similar to those of the transmission method, they are not repeated here.

Other aspects and advantages of the invention will emerge from a reading of the following detailed description of particular embodiments, given by way of non-limiting examples. The description refers to the accompanying drawings, in which:

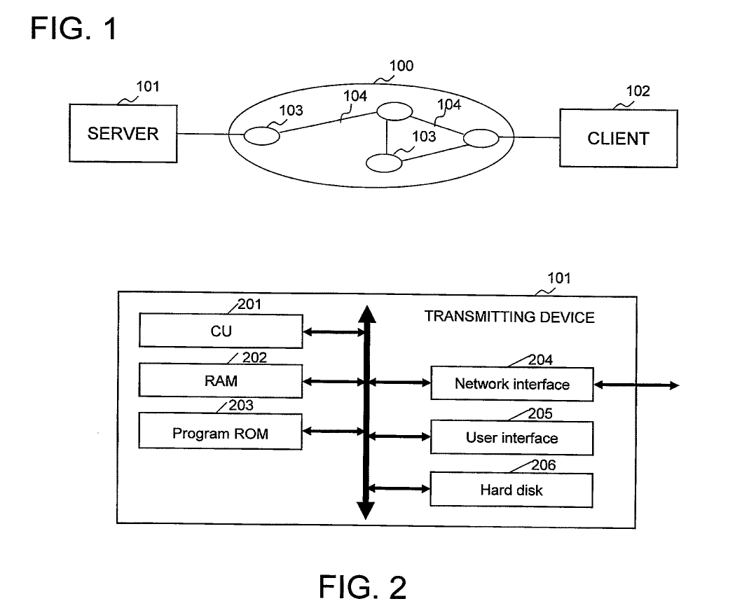

FIG. 1 depicts schematically a data communication network of the distributed type able to implement the present invention;

FIG. 2 depicts schematically a particular embodiment of a transmitting device adapted to implement the present invention;

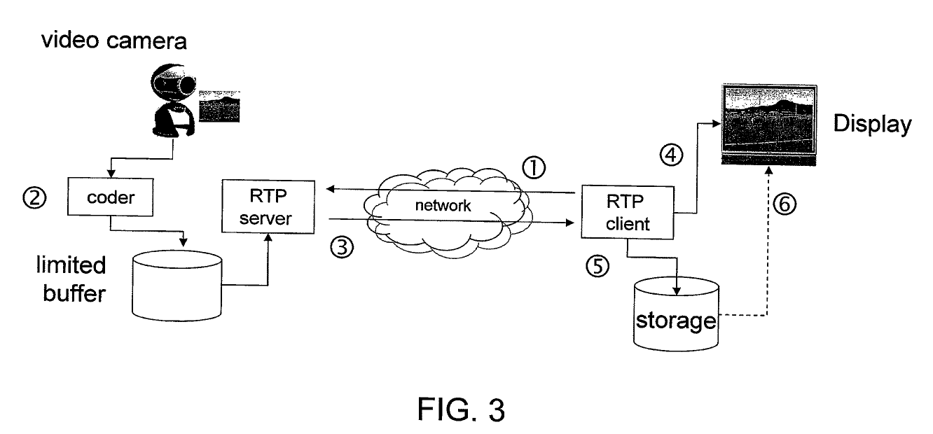

FIG. 3 is an outline diagram illustrating the main steps of a transmission method according to the present invention, in a particular embodiment;

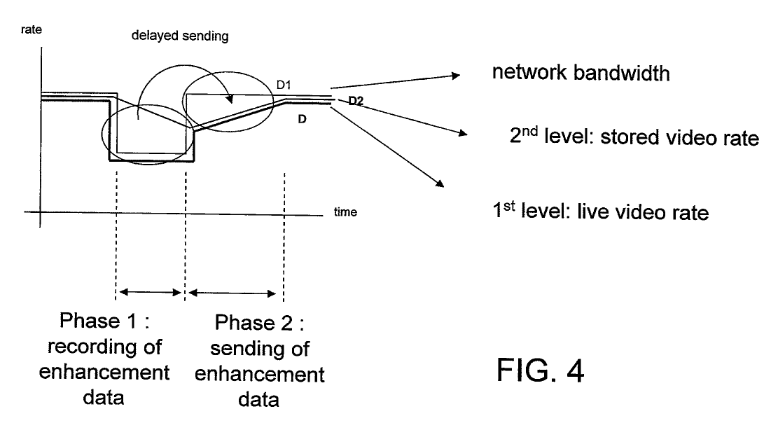

FIG. 4 is a graph showing the general principle of a first algorithm implementing the invention;

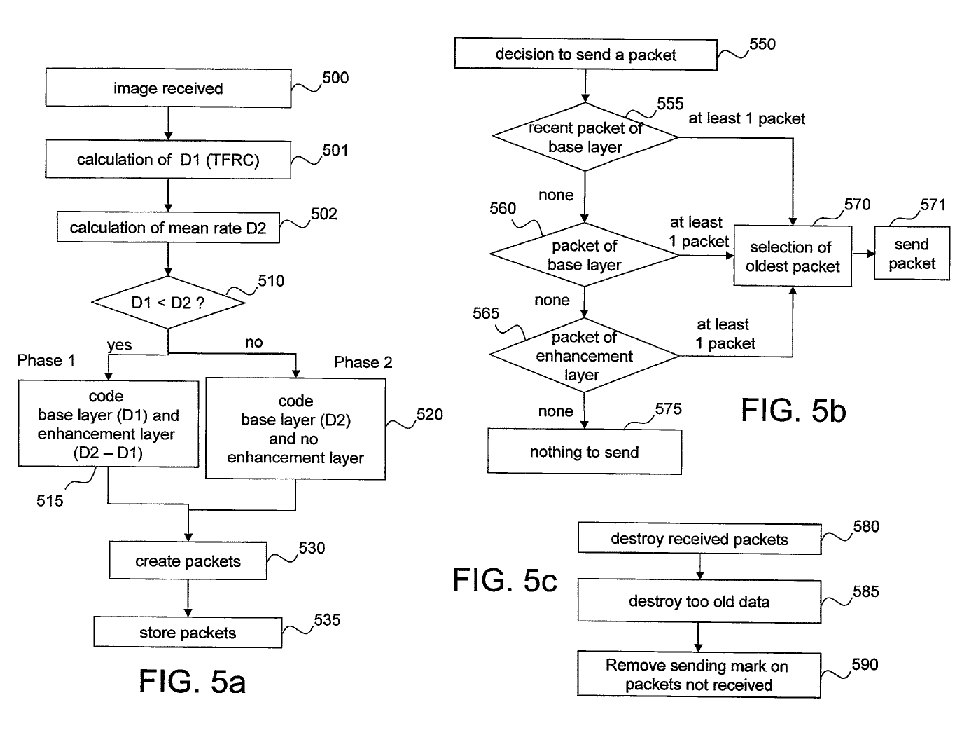

FIGS. 5a, 5b and 5c are flow diagrams illustrating the main steps of the algorithms used by a server according to the present invention, in a particular embodiment;

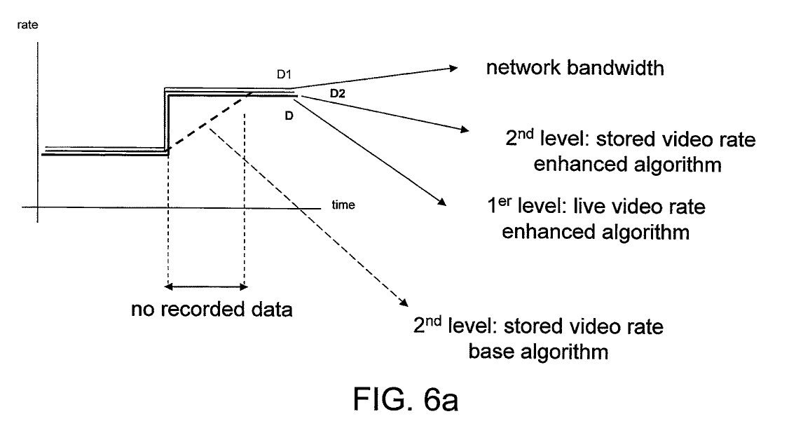

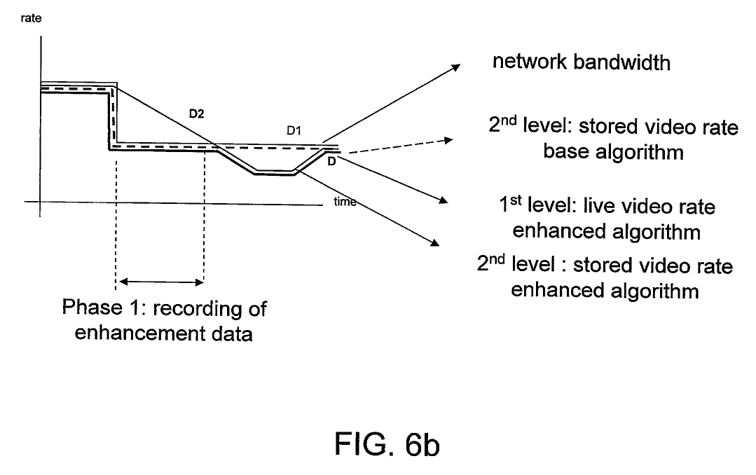

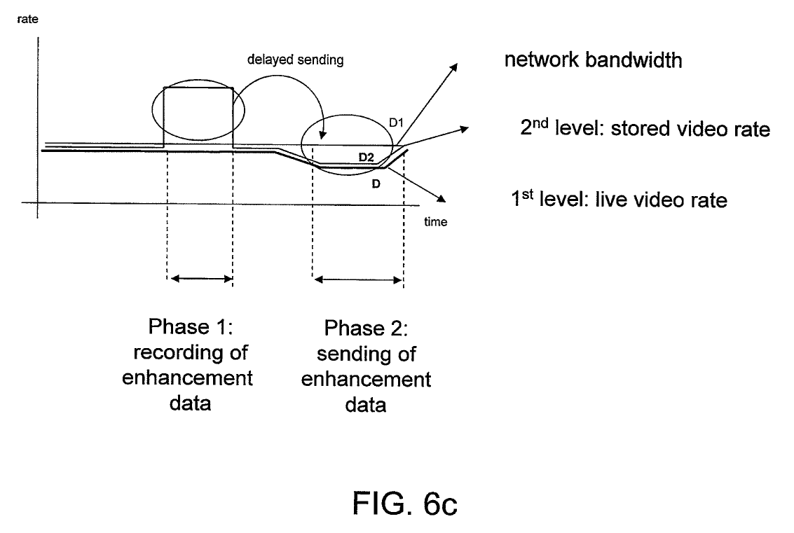

FIGS. 6a, 6b and 6c are graphs showing particular cases for calculating the mean network rate in accordance with the present invention, in particular embodiments;

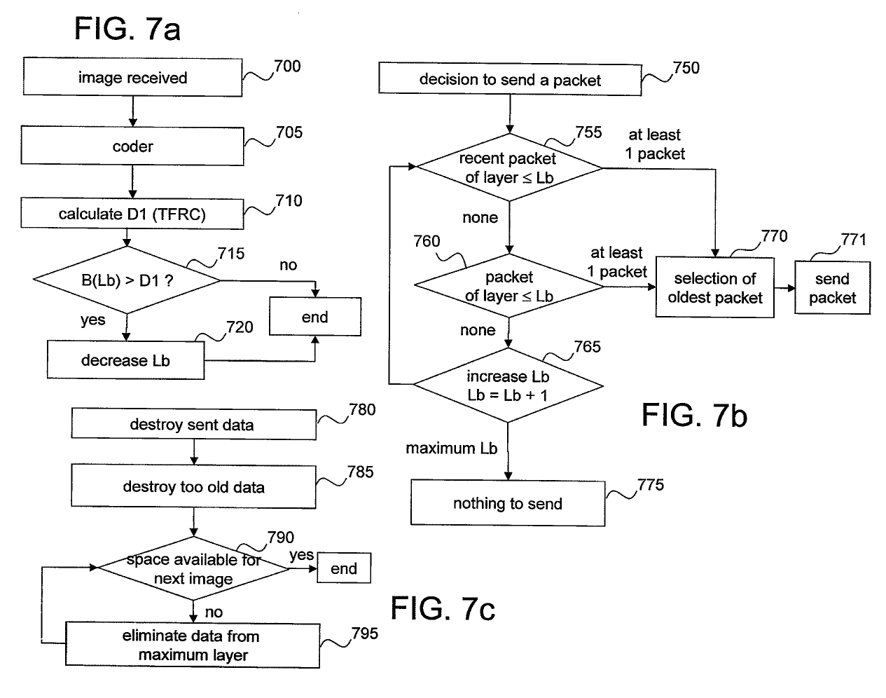

FIGS. 7a, 7b and 7c are flow diagrams illustrating the main steps of the algorithms used by a server according to the present invention, in a variant embodiment;

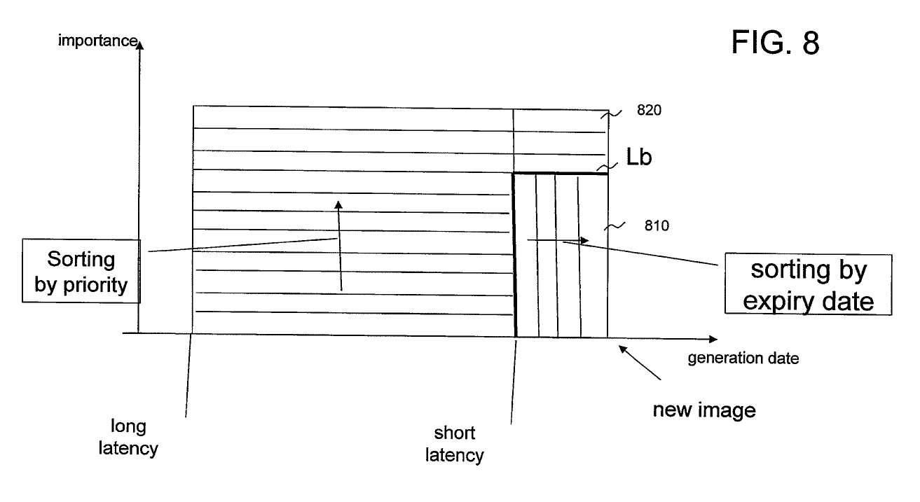

FIG. 8 is a graph depicting schematically the content of the buffer memory of a server implementing the present invention, in a particular embodiment; and

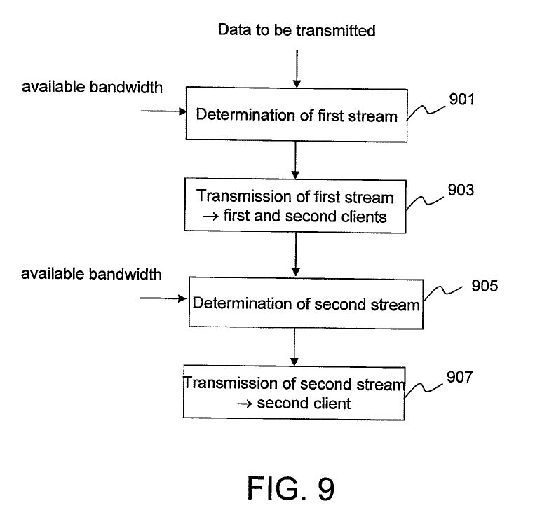

FIG. 9 is a flow diagram illustrating the main steps of a data transmission method according to the present invention, in its generality.

FIG. 1 shows an example of a data communication network where the present invention can be implemented.

A transmitting device or server 101 transmits data packets of a data stream to a receiving device or client 102 over a data communication network 100.

The network 100 can contain interconnection nodes 103 and connections 104 that create paths between the transmitting and receiving devices.

The interconnection nodes 103 and the receiving device 102 can reject data packets in the event of congestion, that is to say in the event of overflow of the reception memory.

The network 100 can for example be a wireless network of the WiFi/802.11a or b or g type or an Ethernet or Internet network.

The data stream supplied by the server 101 can comprise video information, audio information, combinations of the two, or any other type of information that can incorporate a base layer (or first quality level) and at least one enhancement layer (or second quality level).

An example of such a data stream is an MPEG video stream comprising various types of video frames such as key frames (I), forward predictive frames (P), and forward and backward predictive frames (B), where key frames serve as a basis for the processing of the forward and backward predictive frames. The I frames therefore represent the basic data since the loss of a single I frame makes correct processing of the associated P and B frames impossible. The P frames represent the first enhancement data level since their absence does not prevent the decoder, at the receiving device, from processing the I frames, and does not cause any degraded quality (time-wise). Likewise, the B frames represent a second enhancement level since their absence does not prevent decoding the I and P frames.

It is also possible to use a coding format that supplies several scalability levels: for example H263+ or MPEG4 part 2 FGS, or the new SVC format. In these formats, it is possible to have not only temporal scalability as described previously but also spatial scalability and/or scalability in terms of Signal to Noise Ratio (SNR).

It is also possible to consider the error correcting code mechanisms (of the FEC type) as an enhancement layer. This is because the FECs make it possible to generate redundant information packets which, if they are received, will make it possible to correct possible packet losses in the base layer.

In accordance with the present invention, it is possible to break the initial data item down into a base layer that can be decoded by supplying a first quality level and an enhancement layer, which, if it is decoded with the base layer, makes it possible to obtain better quality.

The transmitting device 101 can be any type of data processing device able to supply a data stream to a receiving device. By way of in no way limiting example, the transmitting device can be a stream server capable of supplying content to clients on demand, for example using the RTP protocol on UDP (User Datagram Protocol) or DCCP (Datagram Congestion Control Protocol) or any other type of communication protocol.

The transmitting device can use a congestion control algorithm of the type mentioned above, namely TFRC or AIMD.

Both the transmitting device 101 and the receiving device 102 can be for example a device as depicted in FIG. 2. The terminals can communicate directly by means of the global network 100.

FIG. 2 indeed illustrates in particular a transmitting device 101 adapted to incorporate the invention, in a particular embodiment.

Preferably the transmitting device 101 comprises a central processing unit (CU) 201 capable of executing instructions coming from a program read only memory (ROM) 203 when the transmitting device is powered up, as well as instructions concerning a software application coming from a main memory 202 after powering up.

The main memory 202 is for example of the random access memory (RAM) type and functions as a working area of the CU 201. The memory capacity of the RAM 202 can be increased by an optional RAM connected to an extension port (not illustrated).

The instructions concerning the software application can be loaded into the main memory 202 from a hard disk 206 or from the program ROM 203 for example. In general terms, an information storage means that can be read by a computer or a microprocessor, integrated or not into the apparatus, possibly removable, is adapted to store one or more programs whose execution enables the method according to the invention to be implemented.

Such a software application, when it is executed by the CU 201, causes the execution of the steps of the flow diagrams of FIG. 3 or 5 or 7.

The transmitting device 101 also comprises a network interface 204 that enables it to be connected to the communication network 100. The software application, when it is executed by the CU 201, is adapted to react to requests from the client 102 received by means of the network interface 204 and to supply data streams to the client 102 by means of the network 100.

The transmitting device 101 also comprises a user interface 205, consisting for example of a screen and/or a keyboard and/or a pointing device such as a mouse or an optical pen, in order to display information to a user and/or receive inputs from him.

An apparatus implementing the invention is for example a microcomputer, a workstation, a digital assistant, a portable telephone, a digital camcorder, a digital photographic apparatus, a video surveillance camera (for example of the Webcam type), a DVD player or a multimedia server. This apparatus can directly include a digital image sensor, or optionally be connected to various peripherals such as for example a digital camera (or a scanner or any image acquisition or storage means) connected to a graphics card and supplying multimedia data to the apparatus.

The flow diagram in FIG. 9 illustrates the main steps of a data transmission method according to the present invention in its generality.

A communication network of the same type as the network 100 in FIG. 1 is considered. The object of the invention is the transmission of data between a server (of the same type as the server 101 in FIG. 1) and one or more clients (of the same type as the client 102 in FIG. 1).

The data to be transmitted is subjected to a double constraint: on the one hand, it must be able to be transmitted over a period less than or equal to a first latency (hereinafter referred to as “low” or “short” latency), so as to enable a first client to apply a first type of processing to this data.

By way of non-limiting example, if the data is of the video type, the first type of processing can be the live display of the data received from the server.

On the other hand, the data must also be able to be transmitted with a duration less than or equal to a second latency (hereinafter referred to as “long” latency), greater than the first latency, so as to enable a second client to apply a second type of processing to this data. The first and second clients can in practice constitute one and the same client, or be distinct.

In the aforementioned case of video data, the second type of processing can be the storage or recording of the data received, with a view to its subsequent display.

As shown by FIG. 9, a first step 901 consists, for the server, of determining, from all the data to be transmitted and taking account of the available bandwidth on the network, a first data stream having a rate making it possible to comply with the short latency. In the non-limiting example where the data is of the video type, this data is coded in the form of at least two quality layers or levels, including a base layer and one or more so-called enhancement layers. In the context of this example, the coded data included in the first stream can consist of a subset of quality layers and/or portions of quality layers: for example, the base layer (or, more generally, the layer or layers of the lowest quality).

In a particular embodiment, step 901 consists of determining the instantaneous bandwidth available and attributing to the first data stream a rate less than or equal to this bandwidth.

As a variant, step 901 can consist of determining the mean bandwidth available, this mean value being calculated over a period of time corresponding to the short latency, and attributing to the first data stream a rate less than or equal to this mean value.

After step 901, a step 903 consists, for the server, of transmitting the first stream to the first and second clients with the rate that was attributed to this first stream. In this way, the first stream is transmitted in compliance with the short latency.

Following step 901, a step 905 consists, for the server, of determining, from the data not included in the first stream and taking account of the available bandwidth on the network, a second data stream having a rate making it possible to comply with the long latency. In the aforementioned example where the data is of the video type, the data included in the second stream can consist of at least some of the data that is the complement of that contained in the first stream. For example, the coded data in the second stream can consist of a subset of enhancement layers and/or portions of enhancement layers that are complementary to the layers and/or portions of layers of the first stream. In the non-limiting example where the base layer is transmitted partly in the first stream, the rest of the base layer can be transmitted in the second stream.

Step 905 has been illustrated in FIG. 9 after the step 903 of transmitting the first stream. Nevertheless, step 905 can also be performed between steps 901 and 903.

After step 905, a step 907 consists, for the server, of transmitting the second stream to the second client with the rate attributed to this second stream. The second stream is thus transmitted in compliance with the long latency. The rate of the second stream is calculated so that it avoids creating congestion on the network. By way of example, the rate of the second stream can be calculated as the difference between the rate of the first stream and the measurement of the instantaneous rate available in the network at the time of transmission of the second stream.

Thus, for data coded according to one or more layers (for example base layer) having a low-level quality and one or more layers (for example enhancement layer) having a higher level of quality:
the first stream contains at least one portion of a layer (for example base layer) having a low-level quality; it can be transmitted with a relatively low rate that complies with the short latency; and
the second stream contains elements of data not transmitted in the first stream, which relate to at least one portion of a layer (for example enhancement layer) not transmitted in the first stream and having a higher level of quality than the portion of a layer (for example base layer) of the first stream relating to the same data; the second stream can be transmitted with a higher rate that complies with the long latency.

Particular embodiments of the invention where the data to be transmitted is coded in the form of several quality levels or layers are described below in relation to FIGS. 3, 5 and 7.

FIG. 3 presents the main steps of implementation of the invention, in a first particular embodiment. A user is in front of a screen that is connected to a network. An apparatus capable of generating a video stream is connected to this same network. In the example illustrated in FIG. 3, this apparatus is a video camera.

As shown in FIG. 3, during a step 1 of starting the application, the user configures the client so that it connects to the server. For this, the client sends a request requesting to receive a video. In this request, the client specifies to the server that the video has a double usage: the client wishes, on the one hand, to be able to display the video with low latency and, on the other hand, to be able to save it, with a view to any subsequent display.

This request can be sent using, for example, the RTSP (Real-Time Streaming Protocol) protocol.

Then, during a step 2, the server codes the video in the form of two quality levels or layers: a first base layer and an enhancement layer. The rate of each layer is calculated according to an evaluation of the rate (or bandwidth) available on the network. The coded data is stored in a local buffer before being transmitted to the client.

Next, during a step 3, the server selects some of the data from the local memory to be sent. The base layer is transmitted with a low latency. The enhancement layer is transmitted with a variable latency.

The client receives, decodes and immediately displays the data that arrives with a sufficiently low latency (step 4). This data contains at least the base layer.

Simultaneously (step 5), the client stores all the data received: base layer and enhancement layer.

Subsequently (step 6), the user can request to display the video stored. He can then display a video of better quality than that displayed live, since all the data (base layer and enhancement layer) is available.

It would be possible to envisage other examples of implementation of the invention. In particular, the role of the client could be distributed between several devices: a first device sending a request (step 1) for receiving the video live (step 4) with a low latency and a second device requesting the same stream with a second RTSP request tolerating a long reception latency (step 1a, at the same time as step 1) for storing the video (step 5).

In such an implementation, the server sends the video using two multicast communications: the first communication (concerning the base layer) is broadcast simultaneously to the two clients, while the second (concerning the enhancement layer) is received solely by the storage device.

The graph in FIG. 4 shows the principle of a first algorithm implementing the present invention. The algorithm calculates the rate of the base and enhancement layers and proceeds with the selection of the data to be sent.

In FIG. 4, the curve D1 shows an example of change in the instantaneous rate of the network seen by the server. This rate can be evaluated in various ways. The server can for example use a congestion control algorithm such as TFRC or AIMD (similar to TCP) in order to determine at any time the quantity of data to be sent. The rate D1 can be directly the value given by the congestion control algorithm or it can be measured by calculating an average of this value over a short period less than the latency of the live display.

The server also calculates a mean network rate D2, by calculating a mean of the instantaneous rate over a longer period, equal for example to the latency of the storage device or to the length of the server buffer.

In the example illustrated in FIG. 4, the instantaneous rate D1 undergoes a significant and rapid drop over a short period, before returning to its initial level. The mean rate D2 therefore drops progressively, and then rises again slowly.

The principle of the algorithm is to have a recording phase (called “phase 1” on the drawing) when the instantaneous rate D1 is less than the mean rate D2. During this phase, the server codes a base layer at the rate D1 and immediately sends it to the client. The enhancement data is created at the rate D2-D1 and is stored in the server buffer.

In a second phase (called “phase 2” on the drawing), when the instantaneous rate is sufficient (D1 is greater than D2), the server codes the base layer at the rate D2 and sends it immediately. On the other hand, it does not create any enhancement data and the difference between the instantaneous rate and the mean rate is used to send to the client the data stored in the server buffer.

The user will thus obtain, at the time of the live display, a quality corresponding to the base layer at the rate D=min (D1, D2) and, at the time of display of the recording, a quality corresponding to the rate D2 that will be greater than the live quality.

The flow diagram of FIG. 5a illustrates the main steps of the algorithm used by the server in the first particular embodiment of the invention, for calculating the coding rate of the layers of the video. This embodiment is particularly appropriate in the case where the data stream is organized in the form of packets and where the server and client use a system of acknowledgment of the packets received and of retransmission in the case of a lost packet.

During a previous step, not shown, two items of latency information were communicated to the server: a low latency with which the client wishes to be able to display the video received live and a greater latency with which the client can receive the video in order to save it with a view to a possible subsequent display.

At step 500, the server takes the following image to be coded.

At the following step 501, the server calculates the instantaneous rate (or bandwidth) D1 of the network. This calculation can be made for example using a congestion control algorithm of the TFRC type as mentioned previously.

Then, at step 502, the server determines the new mean rate (or bandwidth) D2 of the network at the current instant. For this the server can use the value of the rate D1 at the same instant and the value of the mean rate at the previous instant, stored in the same variable D2. The new value of the mean rate is obtained by effecting a weighted sum of these two values: a.D1+b.D2 with, for example, a=0.1 and b=0.9.

However, if the server buffer is empty, D2 is fixed equal to D1. This particular case is explained below in relation to FIG. 6.

The server next compares the instantaneous rate D1 with the mean rate D2 (test 510).

If the instantaneous rate is lower than the mean (D1<D2), this gives phase 1 illustrated in FIG. 4 (step 515 in FIG. 5a). The server then codes the image with a base layer at rate D1 and an enhancement layer at rate D2-D1.

If the instantaneous rate is greater than or equal to the mean (phase 2 in FIG. 4) (step 520 in FIG. 5a), the server codes the image with only a base layer at the mean rate D2 and without any enhancement layer.

At the end of step 515 or 520, during a step 530, the server creates the packets, for example in accordance with the RTP protocol, to be sent. The data is divided up taking account of the structure in slices of the video as well as of the maximum size of the network packets. The RTP headers are added. With each packet there is associated creation date information (the time at which the image was entered) and the indication of the layer.

The packets with the associated information are then stored in the local buffer memory (step 535). In the case where the memory is too limited in the server buffer, it may be necessary to destroy the oldest packet in the buffer in order to make space for the new packet.

The flow diagram in FIG. 5b illustrates the steps of selecting the packets to be sent. This algorithm is executed whenever the server decides to send a packet. Where a congestion control algorithm of the TFRC type is used, it is this algorithm that determines the time of sending a packet (step 550).

The server first of all tests whether there exists at least one recent unsent packet of the base layer (test 555). A recent packet is a packet that can arrive with the low display latency. To assess whether a packet is recent, its associated date and the current date are compared; it is considered that the packet is recent if the difference between these two dates is less than the short latency minus the time of transmission to the client. If at least one such packet is found, step 570 can be passed to.

If no packet has been found, the server then seeks all the unsent packets of the base layer that are not too old, that is to say that can be received in compliance with the long latency (test 560). If at least one such packet is found, step 570 can be passed to.

Otherwise the server seeks all the remaining unsent packets (that is to say all the packets of the enhancement layer) that are not too old (test 565). If at least one such packet is found, step 570 can be passed to.

At step 570, the server takes the packet having the oldest date from all the packets selected. This packet is marked as sent with its sending date (it will be destroyed subsequently, as described below in relation to FIG. 5c) and is sent to the client (step 571).

If no packet is selected, the server sends nothing (step 575).

The flow diagram of FIG. 5c illustrates the main steps for updating the buffer memory of the server.

The server will execute this algorithm regularly, namely whenever it receives a feedback from the client indicating that a packet has been received and on the basis of a given timer.

At step 580, the packets whose reception has been confirmed by the client (possibly after an Automatic Repeat Request ARQ, if an error correction is necessary) are destroyed.

At step 585, the too old packets are destroyed. A too old packet is a packet whose creation date indicates that it can no longer be received in compliance with the reception latency of the client for storage.

Finally, at step 590, the server checks the packets sent but whose reception has not been confirmed. If a too long time has elapsed (typically a period greater than the round-trip time between the server and the client), the state of the packet is changed so that this packet can once again be sent: the marker indicating that the packet has been sent is removed.

The graph in FIG. 6a illustrates a particular case of step 502.

It is the case where the bandwidth, evaluated for example by means of a congestion control algorithm of the TFRC type, remains stable at a first low level for a long period, and then increases abruptly to a second high level. In this case, the mean value of the rate will increase slowly (this is illustrated by the broken-line curve in the drawing). This would enable the server to send possible data stored.

However, in the case where no data item is present in the server buffer, it is unnecessary to reserve any bandwidth. This is the reason why the test is performed on the state of the buffer (mentioned in the description of step 502 in FIG. 5a) in order to decide on the value of the mean rate D2.

In more general terms, it is possible to use the filling level of the buffer and the relative levels of D1 and D2 in order to modify the weightings a and b of D1 and D2 in the formula used at step 502.

The symmetrical case of a continuous decrease in the network rate is illustrated in FIG. 6b. The instantaneous rate D1 of the network is evaluated at a high level and then drops abruptly to a lower level but never rises again.

In this case, there is a phase of creation of enhancement data that is stored (“phase 1” in the drawing). However, this data cannot be sent subsequently. In accordance with the algorithm in the FIG. 5c, the server will end by eliminating this data without sending it.

A variant taking account of the state of the server buffer in order to calculate the mean rate D2 could consist of temporarily decreasing the coding rate to allow the sending of the enhancement data.

Another particular case, illustrated in FIG. 6c, can be taken into account with a more complex calculation of D2.

Indeed, at step 502, account can also be taken of the complexity of the image and of the video in calculating D2. The rate control algorithm can choose the quantization parameters, and therefore the rate, according to several parameters:
a rate-distortion model (by way of example, known models used in the context of MPEG compression are TMN-5 or TMN-8),
the bandwidth evaluated,
the current quantization step,
a psycho-visual model (knowing that rapid variations in quantization step are to be avoided), and
the degree of filling of the server buffer.

It is thus possible to decide to avoid rapid modifications to the quantization step when the buffer is not very filled, even if the instantaneous network rate is temporarily not complied with because of this.

Thus, as shown by FIG. 6c, after a stable start, a scene of the video becomes more complex to code (for example, because of complex and rapid movements). In this case, in order to keep a stable quality, it is necessary to code the video with a higher rate. As the network rate has not changed, the rate of the base layer remains unchanged, with consequently a degraded quality. However, an enhancement layer is created and stored locally in the server buffer.

In a second phase, the complexity of the video decreases. The server can then decide to decrease the rate granted to the video, for the purpose of being able to send the data stored and therefore the enhancement layer.

The flow diagrams in FIGS. 7a, 7b and 7c illustrate a second particular embodiment of the invention, in the case where the server uses a multi-layer coding, for example with a codec of the SVC type, which makes it possible to have several enhancement layers.

The successive enhancement layers of the video are denoted LO, L1, . . . , Ln. The value Lb is the level of the limit between the layers sent live (base layers) and the layers sent in a delayed fashion.

The flow diagram in FIG. 7a shows the coding of an image.

During a first step 700, the server receives a new image. It codes it (step 705) in the form of several layers Li so that the set of all the levels provides maximum quality. The data is stored in the server buffer.

The server next calculates the instantaneous rate (or bandwidth) D1 (step 710), for example by taking the value supplied by the TFRC congestion control algorithm.

The server next compares the rate of the level Lb of the data to be sent as a priority (denoted B(Lb)) with the network instantaneous rate D1 (step 715). If the rate of the level Lb is too great, that is to say if B(Lb)>D1, the server recalculates the level Lb of the data to be sent live. In this case, it decreases Lb.

For this, the server calculates the level Lb so that the rate of the layer Lb (including the levels LO as far as Lb) is less than the instantaneous rate D1 (B(Lb)<D1) and the top layer Lb+1 has a rate greater than D1 (B(Lb+1)>D1) (step 720). The level Lb is then used during the selection of the packets to be sent (described below in relation to FIG. 7b). This calculation makes it possible, during phase 1 of recording of the enhancement data, to rapidly decrease the quality level of the data sent live when there is a drop in the network rate, as in the embodiment in FIG. 5a.

The flow diagram of FIG. 7b shows the selection of the packets to be sent. As in the embodiment in FIG. 5b, the algorithm in FIG. 7b is executed whenever the server decides to send a packet. Likewise also, in the case where a congestion control algorithm of the TFRC type is used, it is this algorithm that determines the instant at which a packet must be sent (step 750).

The server begins by checking whether there exist unsent recent packets belonging to a layer to be sent live (layer with a level lower than or equal to Lb) (test 755). As in the embodiment in FIG. 5b, a recent packet is a packet that can be received before the expiry of the low latency period. If such packets exist, they are selected and step 770 is passed to. Otherwise test 760 is passed to.

Test 760 consists, for the server, of testing whether there exists at least one unsent packet of a layer lower than or equal to Lb and which is not too old (that is to say it can be received in compliance with the long latency). If such is the case, all the corresponding packets are selected and step 770 is passed to.

Otherwise step 765 is passed to, where the value of Lb is increased in order to pass to the immediately higher layer (Lb+1) before returning to step 755. This step allows, during the second phase (sending of the enhancement data), a progressive increase in the quality level of the data sent rapidly at the same time as the sending of the previously stored enhancement data.

If the maximum value of Lb is reached (Lb=Ln), no packet is available and therefore no packet can be sent (step 775).

At step 770, the server chooses the oldest packet in all the packets selected. The packet chosen is sent (step 771) and removed from the buffer.

The flow diagram in FIG. 7c illustrates the algorithm for updating (by destruction of the data) the server buffer, which is carried out regularly, at least before each image coding.

The data already sent is deleted (step 780). The too old data is then destroyed (step 785). A data item is considered to be too old if it cannot be received before the expiry of the long-latency period.

The server then checks whether the memory space available in the buffer is sufficient to store the next coded image (test 790). If the available space is not sufficient, the server eliminates the data of the maximum layer still present in the buffer (step 795) before returning to test 790.

If the available space is sufficient, the updating algorithm terminates.

It should be noted that, in this second embodiment, as in the first and as illustrated in FIG. 4, a drop in the instantaneous rate D1 leads to a drop in the quality of the data sent live and to the storage of the enhancement data (phase 1) and an increase in the instantaneous rate D1 causes a progressive increase in the quality with the sending of stored data (phase 2).

In addition, the two variants of the invention presented in FIGS. 5a, 5b and 5c, on the one hand, and in FIGS. 7a, 7b and 7c, on the other hand, manage the server buffer in a similar fashion.

The content of the buffer memory of the server is shown schematically in FIG. 8. The new data corresponding to a new image is inserted by the coder to the right on the graph (by increasing generation date). The data is shown by increasing importance from bottom to top. The threshold corresponding to the limit between the base layer sent live and the enhancement layer sent later is displayed by the threshold Lb.

Two time thresholds exist:
short latency: the data to the right of this threshold in the drawing can be sent on time so as to be received and displayed by the client.
long latency: the data older than this threshold no longer have any interest and can be destroyed.

The two embodiments described above send the data from zone 810 as a priority: the data that is recent and that relates to the base layer. This data is sent in order of increasing expiry date.

When the zone 810 is empty, the data from the rest of the buffer (zone 820) is sent. This remaining data is sent in order of increasing importance and then, for the data of the same importance, in order of increasing expiry date.

1. A method of transmitting data between a server and at least one client in a communication network, said data having to comply with a first transmission latency, suiting a processing of a first type to be performed by a first client, and a second transmission latency greater than the first transmission latency and suiting a processing of a second type to be performed by a second client, the first and second clients being able to be distinct or not, said method comprising steps consisting, for the server, of:
determining, from said data, taking account of the variable available bandwidth in said network, a first data stream having a rate making it possible to comply with said first latency;
transmitting said first data stream to said first and second clients;
determining, from the data not included in said first data stream, taking account of the variable available bandwidth in said network, a second data stream having a rate making it possible to comply with said second latency; and
transmitting said second data stream to said second client,
wherein the calculation of the rate of said first stream takes account of the unsent quantity of data of said second stream.

2. A method according to claim 1, wherein the step of determining the first stream comprises a step consisting of determining the instantaneous bandwidth available in said network and in that the rate of the first stream is less than or equal to the available instantaneous bandwidth determined.

3. A method according to claim 1, wherein the step of determining the first stream comprises a step consisting of determining the mean bandwidth available in said network over a period of time corresponding to the first latency and in that the rate of the first stream is less than or equal to the available mean bandwidth determined.

4. A method according to claim 1, in which the data is coded according to a first quality level and a second quality level higher than the first level, wherein said first stream comprises at least some of the data having said first quality level and said second stream comprises at least some of the data having said second quality level.

5. A method according to the claim 4, in which the data is organized in packets, a creation date being associated with each packet, comprising a step consisting, for the server, of comparing the date of creation of the untransmitted packets having said first quality level with the current date and determining whether the difference between these two dates is less than said first latency minus the transmission time between the server and said first client.

6. A method according to claim 1, in which the data is coded according to a first plurality of quality levels and a second plurality of quality levels higher than the levels of said first plurality of levels, wherein said step of determining the first data stream comprises steps consisting, for the server, of:
determining the instantaneous bandwidth of the network;
comparing said instantaneous bandwidth and the bandwidth of the maximum quality level of said first plurality of quality levels;
if said instantaneous bandwidth is lower than said bandwidth of the maximum quality level, decreasing the maximum quality level of said first plurality of quality levels so that the bandwidth of the decreased maximum quality level is less than said instantaneous bandwidth and the bandwidth of the quality level immediately higher than the decreased maximum quality level is higher than said instantaneous bandwidth.

7. A method according to claim 1, wherein the communication network is a wireless network.

8. A method according to claim 1, wherein the data stream is a video stream.

9. A server for the transmission of data between a server and at least one client in a communication network, said data having to comply with a first transmission latency, suited to a processing of a first type to be performed by a first client, and a second transmission latency, greater than the first transmission latency and suited to a processing of a second type to be performed by a second client, said first and second clients being able to be distinct or not, said server comprising:
means for determining, from said data, taking account of the variable available bandwidth in said network, a first data stream having a rate making it possible to comply with said first latency;
means for transmitting said first data stream to said first and second clients;
means for determining, from the data not included in said first data stream, taking account of the variable available bandwidth in said network, a second data stream having a rate making it possible to comply with said second latency; and
means for transmitting said second data stream to said second client,
wherein the calculation of the rate of said first stream takes account of the unsent quantity of data of said second stream.

10. A server according to claim 9, wherein the means of determining the first stream are adapted to determine the instantaneous bandwidth available in said network and in that the rate of the first stream is less than or equal to the available instantaneous bandwidth determined.

11. A server according to claim 9, wherein the means of determining the first stream are adapted to determine the mean bandwidth available in said network over a period of time corresponding to the first latency and in that the rate of the first stream is less than or equal to the available mean bandwidth determined.

12. A server according to claim 9, in which the data is coded according to a first quality level and a second quality level higher than the first level, wherein said first stream comprises at least some of the data having said first quality level and said second stream comprises at least some of the data having said second quality level.

13. A server according to the claim 12, in which the data is organized in packets, a creation date being associated with each packet, comprising means adapted to compare the creation date of the untransmitted packets having said first quality level with the current date and determining whether the difference between these two dates is less than said first latency minus the transmission time between the server and said first client.

14. A server according to claim 9, in which the data is coded according to a first plurality of quality levels and a second plurality of quality levels higher than the levels of said first plurality of levels, wherein said means of determining the first data stream are adapted to:
determine the instantaneous bandwidth of the network;
compare said instantaneous bandwidth and the bandwidth of the maximum quality level of said first plurality of quality levels;
if said instantaneous bandwidth is lower than said bandwidth of the maximum quality level, decrease the maximum quality level of said first plurality of quality levels so that the bandwidth of the decreased maximum quality level is less than said instantaneous bandwidth and the bandwidth of the quality level immediately higher than the decreased maximum quality level is higher than said instantaneous bandwidth.

15. A server according to claim 9, wherein the communication network is a wireless network.

16. A server according to claim 9, wherein the data stream is a video stream.

17. An information storage means readable by a computer or a microprocessor storing instructions of a computer program, allowing the implementation of a method of transmitting data between a server and at least one client in a communication network, said data having to comply with a first transmission latency, suiting a processing of a first type to be performed by a first client, and a second transmission latency greater than the first transmission latency and suiting a processing of a second type to be performed by a second client, the first and second clients being able to be distinct or not, said method comprising steps consisting, for the server, of:
determining, from said data, taking account of the variable available bandwidth in said network, a first data stream having a rate making it possible to comply with said first latency;
transmitting said first data stream to said first and second clients;
determining, from the data not included in said first data stream, taking account of the variable available bandwidth in said network, a second data stream having a rate making it possible to comply with said second latency; and
transmitting said second data stream to said second client,
wherein the calculation of the rate of said first stream takes account of the unsent quantity of data of said second stream.
